(19) United States
(12) Patent Application Publication
(10) Pub. No.: US 2002/0103762 A1
(43) Pub. Date: Aug. 1, 2002

(54) Method and apparatus for managing access to a prepaid account

(75) Inventors: Cesar Garcia Lopez, Saltillo (MX); Juan Sanchez Garza, Saltillo (MX); Omar Torres Morales, Saltillo (MX)

Correspondence Address: Mark V. Muller, Jenkens & Gilchrist, P.C., 3200 Fountain Place, 1445 Ross Avenue, Dallas, TX, 75202-2799, US

(73) Assignee: TELEFONAKTIEBOLAGET L M ERICSSON (publ)

(21) Appl. No.: 09/770,144

(22) Filed: Jan. 26, 2001

(51) Int. Cl. G06F 17/60; H04K 1/00; G01R 21/133; G06F 17/00; H04L 9/00; G01R 11/56

(52) U.S. Cl. 705/63; 705/412; 705/41; 705/1

(57) ABSTRACT

A prepaid communications account is shared by at least a first subscriber and a second subscriber whereby access to the prepaid account is locked in response to a first prepaid call originating from the first subscriber. A first portion of the total prepaid talk time in the account is allocated to the first prepaid call. The total prepaid talk time is updated as a first updated prepaid talk time by subtracting the first portion from the total prepaid talk time; unlocking access to the prepaid account; and, while the first prepaid call is ongoing, locking access to the prepaid account in response to a second prepaid call originating from the second subscriber. A second portion of the first updated prepaid talk time is allocated to the second prepaid call. The first updated prepaid talk time is updated to provide a second updated prepaid talk time by subtracting the second portion from the first updated prepaid talk time; and access to the prepaid account is unlocked.

A database is utilized for managing access to a prepaid communications account shared by at least a first subscriber and a second subscriber and includes identity fields and associated remaining talk time fields for the subscribers and an associated sponsor identity field.

A memory element is used to store a database for managing access to a prepaid communications account shared by at least a first subscriber and a second subscriber and includes memory locations for the identities and associated talk times and a sponsor identity memory location associated with the first and second identity memory locations.

### BACKGROUND OF THE INVENTION

1. Technical Field

This invention relates generally to prepaid services for telecommunications devices. More particularly, the invention relates to a method and apparatus to manage a single prepaid credit account available to multiple users.

2. History of Related Art

In order to make use of prepaid telecommunications services, several elements are needed: a telecommunications device (e.g. a mobile telephone), subscriber authorization (normally supplied by the service provider), a prepaid subscriber account purchased to establish credit, and some number of telephone calls made to deplete the credit available until no more credit is available.

The current prepaid system provides subscribers with prepaid services, where each subscriber has a unique account which can be accessed only once for each call. Thus, a single prepaid account cannot be accessed several times during a call, for example, to allocate additional time to the account. Nor can currently available prepaid accounts be accessed by several subscribers simultaneously, so that a second subscriber may be allocated prepaid credit while a first subscribers, who has already accessed the account, is engaged in an ongoing call.

Prior art access to prepaid accounts is illustrated in more detail in FIG. 1, which shows a network signal flow diagram for a prepaid account accessed by a single subscriber (i.e., subscriber A). The typical sequence of operations is as follows:

Subscriber A operating telephone 20 dials a destination telephone 80 (i.e., the B-number) in step 90. The B-number is transmitted to the MSC1 30, along with the location information of the telephone 20 in step 100. In step 110, the MSC1 30 obtains the location area of the telephone 20, the B-number, and the A-number (i.e., the owner of the prepaid account), which are then sent to the HLR 40 associated with the MSC1 30 in step 120. In step 130, the HLR 40 forwards the A number and location area to the Prepaid System (PPAS) 50. In step 140, the PPAS 50 calculates the available talk time based on the location area for the telephone 20 subscriber A and locks access to the prepaid account record 57 so that no other subscribers may access the record 57. In step 150, the PPAS 50 responds to the message in step 130 with an available amount of talk time that can be allotted to the telephone 20 subscriber based, in part, on where subscriber A and subscriber B are located. However, it should be noted that the “location area” is only one of many parameters which may be used by the PPAS 50 to determine the talk time available. Other parameters may include, for example, the “subscriber category”, the “cell identification”, the “time hour of the call”, and the “predetermined rate”. Any one or more of these parameters (and other parameters not listed here) may be used by the PPAS 50 to determine the available talk time.

After receipt of the available talk time, the HLR 40 performs normal call delivery operations, such as by sending a RoutingRequest Invoke message including the B-number to the MSC2 70, serving the telephone 80 subscriber (i.e., subscriber B) in step 160. Steps 170 and 180 illustrate the typical paging and paging response messages, respectively, used to alert the telephone 80 that a request to set up a call is in progress. After receiving the telephone 80 response in step 180, the MSC2 70 responds to the RoutingRequest Invoke message of step 160 in step 190, including a temporary local directory number for the telephone 80. After receipt of the response in step 190, the HLR 40 responds to the original message of step 120 with the allotted talk time for the telephone 20 in step 200. The MSC1 30 follows with an announcement request in step 210 to the announcement machine (IVR) 60, and an announcement indicating the allotted talk time is returned from the IVR 60 to the MSC1 30 in step 220. The announcement is sent forward from the MSC1 30 to the telephone 20 in step 230, and the call supervision process begins by the MSC1 30 to determine when the time allotted to the call requested by the A-subscriber reaches zero in step 240. The call is then established over the typical interfaces 250, 260, 270 between the telephone 20, the MSC1 30 and the MSC2 70, and the telephone 80, as are well known to those skilled in the art.

The call in progress proceeds in step 280, until the call is disconnected by the A-subscriber operating the telephone 20, or the B-subscriber operating the telephone 80 in step 290. At this point, the MSC1 30 has control of the talk time available to the A-subscriber, and if any time remains prior to disconnection in step 290, a message is sent in step 300 from the MSC1 30 to the HLR 40, indicating the remaining talk time. The HLR 40 includes the remaining talk time as updated credit information for the A-subscriber in a message to the PPAS 50 in step 310, and the remaining time is converted to credit units and these are credited to the prepaid A-subscriber account in step 320 by the PPAS 50. After the remaining amount is credited, the PPAS 50 unlocks access to the record 57. The credit message of step 310 is acknowledged by the PPAS 50 in step 330, and the HLR 40 acknowledges the update of the talk time to the MSC1 30 in step 340.

Thus, as can be readily seen, the prior art allows only a single subscriber to access a prepaid account, and the account is locked for the duration of any call placed by the prepaid subscriber so as to exclude other subscribers. Therefore, what is needed is a method of managing access to a prepaid communications account shared by more than one subscriber. The method should only lock access to the prepaid account for the time required to update the account by allocating credit to a subscriber before a call begins, or updating credit back to the account after a call is terminated. This would allow simultaneous access of the prepaid account by multiple subscribers. Such a method should also provide for access to prepaid accounts by several subscribers as a sponsored service. A database for managing access to the prepaid communications account would also be useful, especially if it included identity fields for multiple subscribers. The identity fields should be associated with talk time allocated to each individual subscriber, along with an identity field for the sponsored, prepaid account. Finally, a memory element containing a database for managing a shared prepaid account would also be useful as a mechanism for managing such accounts.

### SUMMARY OF THE INVENTION

The invention includes a method of managing access to a prepaid communications account shared by a first and a second subscriber, comprising the steps of locking access to the prepaid account (in response to call origination by the first subscriber), allocating a portion of the total prepaid talk time in the account to the first subscriber, updating the total prepaid talk time by subtracting the portion allocated to the first subscriber, and unlocking access to the prepaid account. The method continues with locking access to the prepaid account while the first subscriber is engaged in the ongoing prepaid call (in response to a second prepaid call origination from a second subscriber), allocating a second portion of the updated prepaid talk time to the second prepaid call, updating the previously-updated prepaid talk time by subtracting the second portion from the previously-updated talk time, and unlocking access to the prepaid account.

The method may include receiving the prepaid telephone numbers associated with the first and second subscribers, and establishing call connections with a prepaid telephone number associated with the prepaid communications account. Thus, the method may include the steps of receiving the prepaid telephone number from the first and second subscribers, and additionally, receiving telephone numbers associated with first and second called parties to calls established with the first and second subscribers, respectively.

The allocated portions of talk time may be announced to the first and second subscribers. The method may also include the step of monitoring unused portions of the talk time allocated to the first and second subscribers as it is reduced during the ongoing calls established on behalf of the first and second subscribers. Either of the calls may be dropped if the remaining portion becomes about equal to zero, and if the remaining portion of the talk time allocated to either subscriber is greater than zero at the end of the calls, it can be credited to the prepaid account. In addition, as an alternative to dropping one of the calls, the method includes the step of allocating an additional portion of the prepaid talk time to one/both of the calls before the remaining portion becomes about equal to zero. During re-allocation of additional talk time, access to the prepaid account will be locked. The remaining talk time may be announced to the subscribers, at any time during the calls that are established typically on a preselected periodic basis.

The invention also includes a database for managing access to the prepaid communications account shared by the subscribers, wherein the database includes a first and second identity field for the first and second subscribers, respectively; a first and second remaining talk time field associated with the first and second identity fields, respectively; and a sponsor identity field associated with the first and second identity fields. The first and second identity fields typically contain the telephone numbers of the first and second subscribers (i.e., the “virtual” prepaid subscribers). The sponsor identity field typically contains the telephone number of a sponsor (i.e. the actual prepaid subscriber) for the shared prepaid communications account. Other elements of the database may include network reference fields associated with the first and second identity fields, which typically contain the network element address (e.g., HLR/SCP, PPAS, etc.) associated with the first and second subscribers, and the time/credit rate associated with the first and second identity fields, which typically contains one or more selected parameters used by the prepaid system to calculate the talk time associated with the first and second subscribers.

The invention also includes a memory element used to store a database for managing access to the prepaid communications account. The memory element includes identity field memory locations for the first and second parties, remaining talk time memory locations for the first and second subscribers, and one or more sponsor identity memory locations. The memory element may also include network reference memory locations and the time/credit rate memory locations associated with the first and second subscriber identity memory locations.

### BRIEF DESCRIPTION OF THE DRAWINGS

A more complete understanding of the structure and operation of the present invention may be had by reference to the following detailed description when taken in conjunction with the accompanying drawings, wherein:

FIG. 1, previously described, is a network operational signaling diagram illustrating prior art management of a prepaid account;

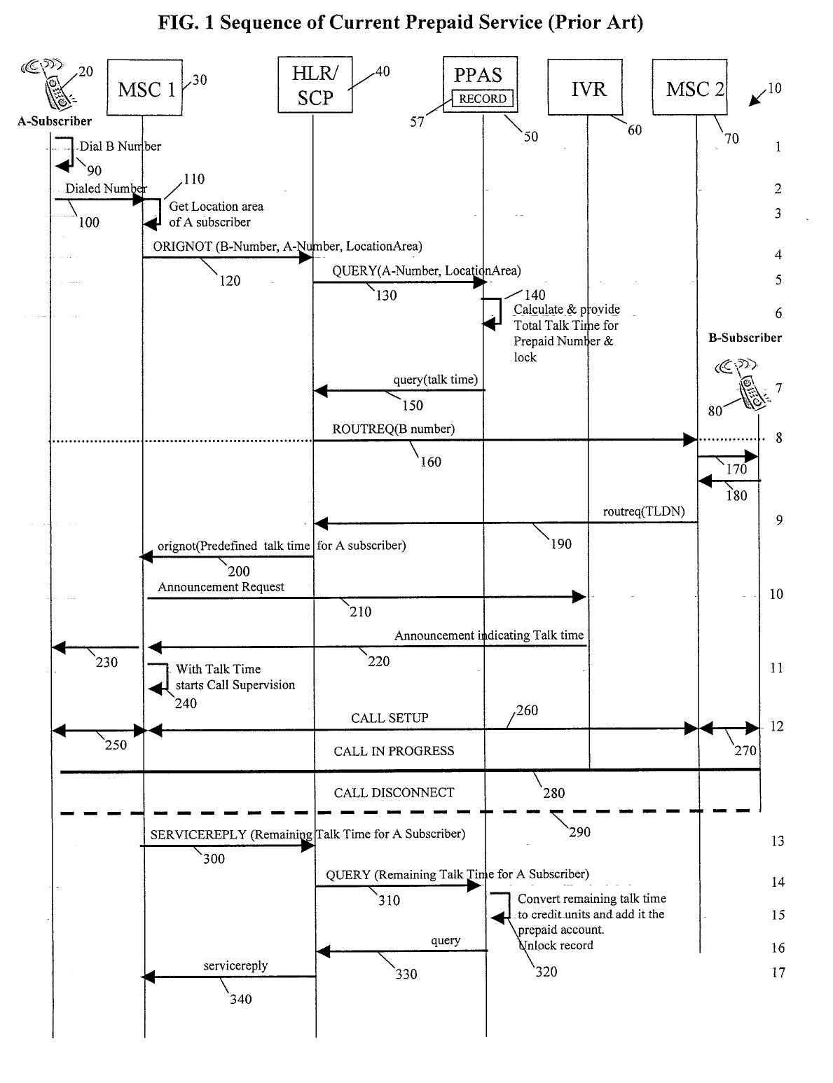

FIG. 2 is a network operational signaling diagram illustrating the method of the present invention during access to a prepaid account by a single subscriber, wherein the call references the sponsor of the prepaid account;

FIG. 3 is a network operational signaling diagram illustrating the method of the present invention during access to a prepaid account by a single subscriber, wherein the prepaid subscriber places a call directly to the sponsor of the prepaid account to obtain toll-free prepaid service in an Intelligent Network;

FIGS. 4A, 4B, and 4C illustrate managed access to a prepaid communications account by multiple subscribers, implementing the method of the present invention; and

FIG. 5 illustrates elements of the database and memory element of the present invention.

### DETAILED DESCRIPTION OF PRESENTLY PREFERRED EXEMPLARY EMBODIMENTS

The method, database, and memory element of the present invention allow access by multiple subscribers to a single prepaid account in real time. Each subscriber may thus access the prepaid system while a special node or database is used to control the access by locking/unlocking the prepaid account. In a first embodiment of the method of the invention, a first subscriber may dial the prepaid sponsor telephone number, along with the telephone number of a first called party (i.e., a B-number). The telephone number of the prepaid sponsor accesses a single prepaid account, of which a portion is to be allocated to the first subscriber, or A-subscriber. The prepaid account is locked, decremented by a preselected portion of talk time, and unlocked. The preselected portion of talk time is then allocated to the A-subscriber, the call to the first called party proceeds while the account remains unlocked, and the account is now available for access by other subscribers.

In a second embodiment of the method of the invention, the A-subscriber may simply dial the telephone number of the prepaid sponsor (e.g., a 1-800 telephone number) to access the managed prepaid account. Again, a portion of the prepaid account is allocated to the A-subscriber, and the telephone call is routed to a corresponding third telephone number using an Intelligent Network Service (INS) network. The prepaid account is then unlocked to allow call access by other subscribers, while the call by A-subscriber proceeds to access the third telephone number.

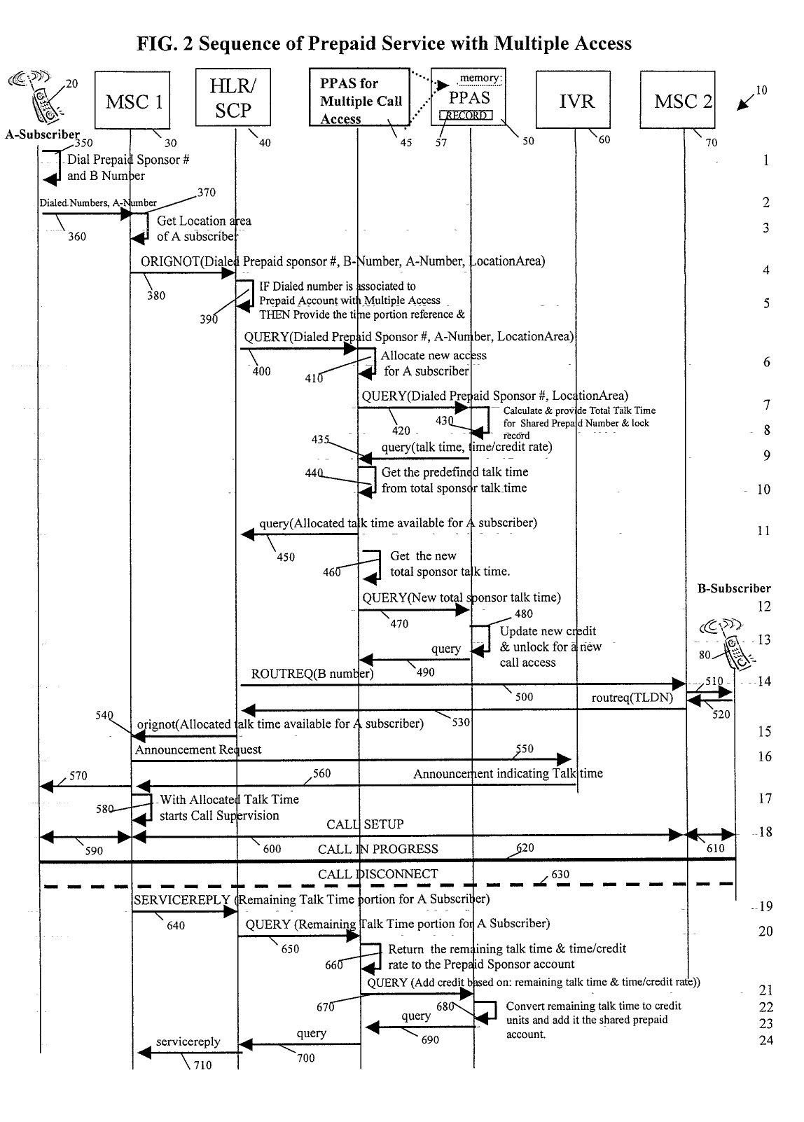

Turning now to FIG. 2, a network operational diagram illustrating the method of the present invention can be seen. The network 10 includes an MSC1 30 (serving the telephone 20) associated with an HLR 40, a prepaid system (PPAS) 50, and an announcement machine (IVR) 60. The network 10 also includes an MSC2 70 serving the telephone 80. A prepaid system for multiple call access (PPAS MCA) 45 is also a part of the network 10, and in electrical communication with the PPAS 50. Alternatively, the PPAS MCA 45 may form an integral part of the PPAS 50.

The method begins in step 350, wherein the A-subscriber operating telephone 20 dials a prepaid telephone number associated with a prepaid communications account 57; along with the B-number of the B-subscriber operating telephone 80. The dialed numbers (i.e., prepaid telephone number and B-number) are transmitted to the MSC1 30, along with the location information of the A-subscriber and the A-number in step 360. The MSC1 30 obtains the A-subscriber location area from the information sent in step 360 at step 370, and the dialed numbers [prepaid telephone number and B-number, along with the A-number,(i.e., the telephone number of the A-subscriber)] are then sent in a message from the MSC1 30 to the HLR 40 in step 380.

At this point, in step 390, if the prepaid telephone number corresponds to a prepaid communications account which provides shared access, then the HLR 40 will forward the associated prepaid telephone number, the predefined time portion (which will be used by the PPAS MCA 50 as a reference to allocate the talk time for the A-Subscriber 20), and the A-number to a prepaid access node (e.g. PPAS MCA) 45 in step 400, which may be a separate node 45, or embodied as a memory element or database within the regular PPAS 50. If the prepaid telephone number does not correspond to an authorized prepaid account, then the telephone call will be handled as a regular telephone call from the A-subscriber to the B-subscriber.

In step 410, the approved A-subscriber (i.e., first subscriber) is authorized as a virtual prepaid subscriber The PPAS MCA 45 sends a request to the PPAS 50, using the prepaid telephone number and the location area, to allocate a portion of the total prepaid talk time available to the prepaid telephone call initiated by the A-subscriber in step 420. The PPAS 50 calculates the available total prepaid talk time based on the location area (and/or other parameters) for the prepaid account and locks access to the prepaid account to prevent other subscribers from manipulating the total prepaid talk time record 57. The prepaid talk time and the time/credit rate (used to calculate the talk time) is sent from the PPAS 50 to the PPAS MCA 45 in step 435, and a portion of the total prepaid talk time is allocated to the A-subscriber responsive to the prepaid call origination by the A-subscriber in step 440. The allocated talk time is based on the predefined time portion information previously received in step 400.

At this time, the PPAS MCA 45 sends the allocated portion of the talk time for the virtual prepaid subscriber (A-subscriber) to the HLR 40 in step 450. In step 460, the PPAS MCA 45 updates the total prepaid talk time by subtracting the allocated portion from the total prepaid talk time in step 460. The PPAS MCA 45 also sends the updated total talk time for the prepaid account to the PPAS 50 in step 470, indicating that the prepaid communications account should be updated with the reduced total prepaid talk time. In step 480, the PPAS 50 updates the prepaid account with the new total prepaid talk time and unlocks access to the prepaid account for use by other subscribers. The PPAS 50 then acknowledges the update to the PPAS MCA 45 in step 490 (assuming that the nodes 45 and 50 are separate entities in the network 10).

Upon receipt of the allocated talk time message in step 450, the HLR 40 performs normal call delivery operations for the B-subscriber in step 500, using a RoutingRequest Invoke message sent to the MSC2 70, which in turn serves the telephone 80 operated by the B-subscriber. The telephone 80 is paged in step 510, and acknowledges the page in step 520, such that the MSC2 70 can acknowledge call delivery using a routingrequest response in step 530. When the HLR 40 receives the response in step 530, the HLR 40 sends a message to the MSC1 30 which includes the allocated talk time and acknowledges the request for call origination in step 380. This occurs in step 540.

The MSC1 30 then requests an allotted time announcement by the announcement machine (IVR) 60, which indicates the allocated talk time available to the A-subscriber in step 550, and the announcement, indicating the allocated talk time, is returned to the MSC1 30 in step 560 by the IVR 60. The announcement is then sent from the MSC1 30 to the telephone 20 operated by the A-subscriber in step 570 and supervision of the call by the MSC1 30 to monitor the unused portion of the allocated talk time begins in step 580. The remaining portion of the allocated talk time is reduced as the prepaid call is established using the network links 590, 600, and 610, indicating typical connections between the telephone 20, the MSC1 30, the MSC2 70, and the telephone 80, which are well known to those skilled in the art.

The call progresses in step 620, until it is terminated in step 630 due to the remaining portion of the allocated portion becoming about equal to zero, or the A-subscriber/B-subscriber hanging up their telephones 20, 80, respectively.

After disconnection occurs in step 630, if there is any remaining portion (greater than about zero) of the unused portion of the allocated talk time for the A-subscriber, the remaining portion is sent as a message from the MSC1 30 to the HLR 40 in step 640, and passed along by the HLR 40 to the PPAS MCA 45. The PPAS MCA 45 then operates to send the remaining talk time portion and the time/credit rate (previously received in step 435) for credit to the prepaid account in step 660, and sends a message to credit the prepaid account to the PPAS 50 in step 670. The PPAS 50 then calculates the credit to be added based on the remaining talk time portion and the time/credit rate, and credits the result to the prepaid account in step 680. The prepaid account update is acknowledged by the PPAS 50 to the PPAS MCA 45 using network messaging in step 690, and in turn, to the HLR 40 in step 700. Finally, in step 710, the request for credit update message sent in step 640 is acknowledge by the HLR 40 to the MSC1 30.

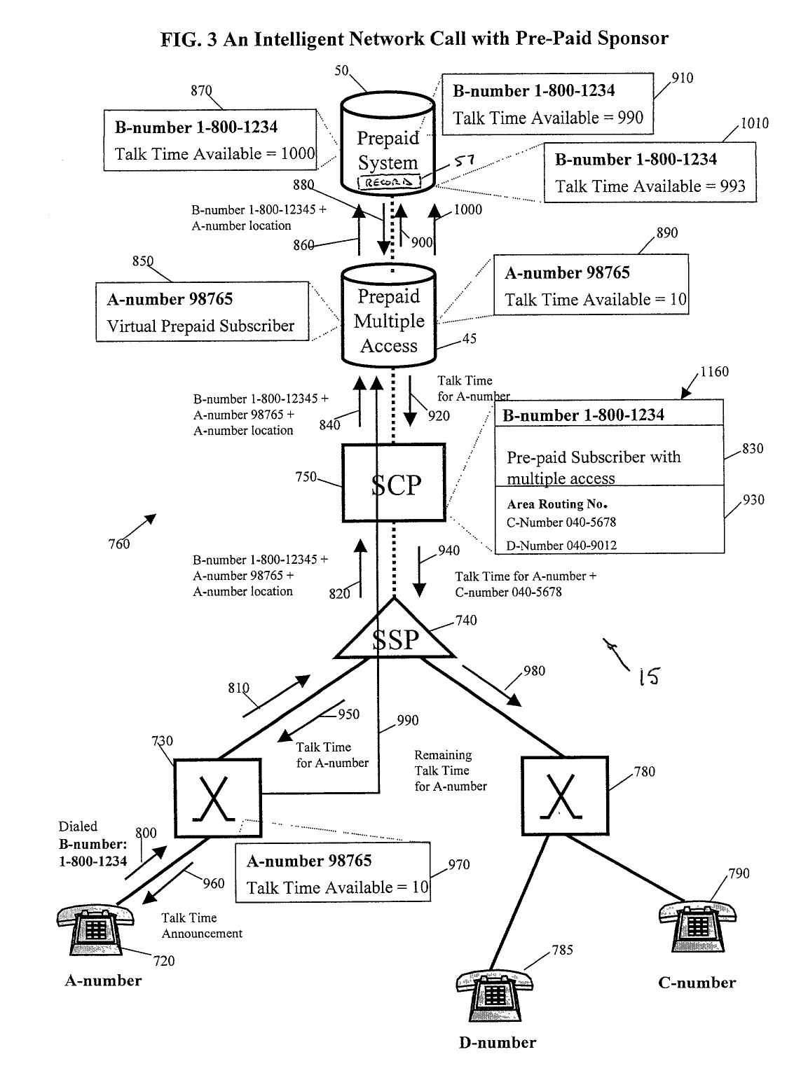

Turning now to FIG. 3, a schematic block diagram of an intelligent network 15 implementing the method of the present invention can be seen. Here the A-subscriber operating the telephone 720 communicates using a local exchange 730 connected to a Service Switching Point (SSP) 740, which in turn routes the call through another exchange 780, connected to the destination telephones 785 and 790. The SSP 740 is connected via the intelligent network 15 to a Service Control Point (SCP) 750, which in turn communicates using network 15 connections with the PPAS MCA 45 and the PPAS 50.

Implementation of the method in this instance involves an illustrated example of managing a prepaid account 57 associated with a toll-free prepaid telephone number. Thus, the A-subscriber operating the telephone 720 uses a toll-free number to access the prepaid account sponsored by the prepaid account subscriber associated with the toll-free number, and the network 15 routes the call to the corresponding C-number at telephone 790.

To begin, the A-subscriber located at the A-number and operating telephone 720 dials the toll-free B-number in step 800. The local exchange 730, to which the telephone 720 is connected, detects that a toll-free number has been dialed and routes the call to the nearest SSP 740 in step 810. The SSP 740 detects the toll-free number and calls the Service Control Point (SCP) 750 in step 820. The database 1160 located in the SCP 750 contains the prepaid account telephone number, and the SCP 750 is then alerted to the fact that the B-number is associated with a prepaid account having shared access. The SCP 750 then requests allocation of a portion of the total prepaid talk time for the A-subscriber by sending the A-number (associated with the calling party operating the telephone 720), A-number location, and the B-number (associated with the prepaid account sponsor, or “actual” prepaid subscribed) to the PPAS MCA 45 in step 840. The PPAS MCA 45 then allocates resources for the A-subscriber in step 850, marking the A-subscriber as a virtual prepaid subscriber. The PPAS MCA 45 then requests the total prepaid talk time available from the prepaid account 57 in step 860, and the total prepaid talk time (e.g., 1,000 minutes) is then calculated by the PPAS 50 according to the location of the telephone 720, and the prepaid account record 57 is locked.

In step 880, the PPAS 50 sends the total talk time and time/credit rate information to the PPAS MCA 45, and the PPAS MCA allocates a portion of the total talk time in step 890 to the A-subscriber (e.g., 10 minutes).

The portion of the total talk time for the prepaid account that is allocated to the calling party subscriber can be fixed, or variable. The amount of time allocated can be based on the type of service requested (e.g., voice conversation, faxes, file transfer, etc.), or the status of the subscriber. Thus, certain subscribers may be allotted larger amounts than others, or some subscribers may be allotted a percentage of the total talk time available, rather than a fixed amount. Other subscribers may be allocated minimal amounts based on promotional schemes, or other considerations.

The PPAS MCA 45 calculates the updated prepaid talk time for the prepaid account by subtracting the portion of the total prepaid talk time allocated to the A-subscriber operating the telephone 720 and returns the updated prepaid total talk time to the PPAS 50 in step 900. The PPAS 50 then updates the prepaid account total talk time in step 910 and unlocks access to the prepaid account to permit other subscribers to access the prepaid account.

The allocated talk time for the A-subscriber is sent from the PPAS MCA 45 to the SCP in step 920 and the SCP 750 translates the toll-free number dialed by the A-subscriber (the B-number) into a final destination (in this case, the C-number for the telephone 790) according to service data in the SCP memory 930. The SCP 750 then sends the portion of the talk time allotted to the A-subscriber and the C-subscriber telephone number to the SSP 740 in step 940, and the talk time allocated to the A-subscriber is sent from the SSP 740 to the local exchange 730 in step 950. The local exchange 730 then requests an announcement from an announcement machine (not shown), to indicate the talk time available to the A-subscriber, and the announcement is returned via the exchange 730 to the telephone 720 in step 960.

Once the local exchange 730 has notified the A-subscriber of the available talk time, the call supervision process begins in step 970 to determine when the allocated available talk time reaches a zero balance (i.e., is about equal to zero). A voice connection is set up between the A-subscriber and the C-subscriber (i.e., between telephones 720 and 790) in step 980, and the local exchange 730 for the telephone 720 takes control of the talk time allocated to the A-subscriber. If ongoing call is disconnected with some remaining portion of the allocated time still available (i.e., the remaining portion is about greater than zero), then the remaining talk time for the A-number is sent to the PPAS MCA 45 in step 990, using a network 15 signaling connection between the SSP 740 and the SCP 750 nodes. The PPAS MCA 45 returns the remaining portion of the talk time and time/credit rate information to the PPAS 50 in step 1000, and the remaining time (e.g., 3 minutes) is converted to credit units and these credit units are credited to the prepaid B-Subscriber account in step 1010. The method of the present invention also provides the option (not shown), to allocate an additional talk time portion to an ongoing call of the A-number before the remaining first talk time portion is about equal to zero in order to continue with the call.

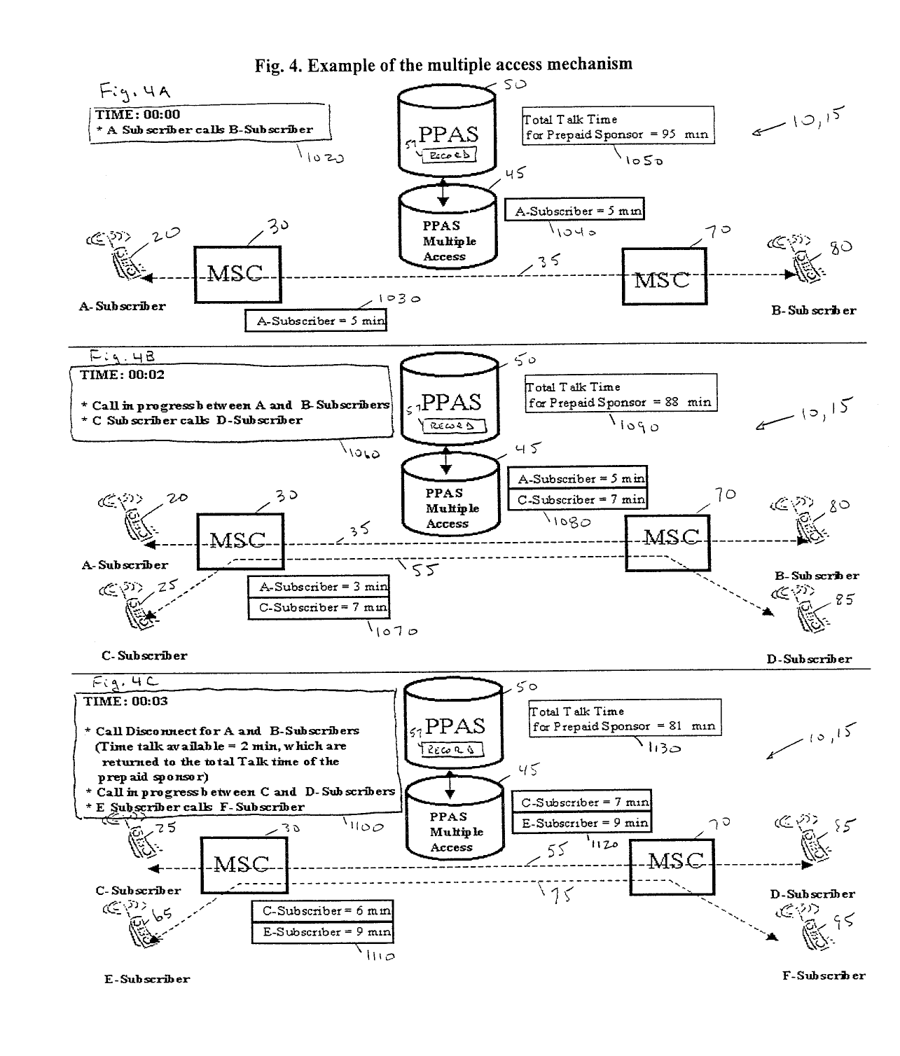

Turning now to FIGS. 4A, 4B, and 4C, abbreviated examples of the method of the present invention implemented within a network 10,15 can be seen. In FIG. 4A, at time 0:00, the A-subscriber operating the telephone 20 calls the B-subscriber operating the telephone 80 in step 1020. The A-subscriber dials the prepaid telephone number associated with the prepaid communications account 57 maintained by the PPAS 50. Since the prepaid account 57 can be shared by multiple users, the PPAS MCA 45 is accessed, and determines that a total of 100 minutes are available for allocation to shared subscribers. The PPAS MCA 45 then locks the prepaid account record 57 in the PPAS 50, allocates 5 minutes to the A-subscriber in step 1040, and subtracts the allocation from the total talk time to leave 95 minutes in step 1050. The updated talk time and time/credit rate information is placed back into the record 57 of the PPAS 50 by the PPAS MCA 45, and the record 57 is unlocked to allow access by other virtual prepaid subscribers. The call is established between the A-subscriber and the B-subscriber using well-known network 10,15 interfaces 35 between the MSC 30 and the MSC 70.

In FIG. 4B, a second shared virtual prepaid subscriber accesses the PPAS MCA 45. At time equal to 0:02 minutes, the C-subscriber operating telephone 25 calls the D-subscriber operating telephone 85 using the same prepaid account telephone number used by the A-subscriber operating telephone 20. This occurs in step 1060. At the time of the call, the A-subscriber has 3 minutes remaining of its allocated talk time, and the C-subscriber is allocated 7 minutes from the total updated remaining talk time of 95 minutes. This occurs by assigning 7 minutes of talk time to the C-subscriber in step 1080, and subtracting it from the updated total talk time in step 1090, to leave a second updated total talk time of 88 minutes in step 1090. The record 57 in the PPAS 50 will be locked, updated, and unlocked in the same manner as that described for access by the A-subscriber in FIG. 4A. After unlocking the record 57, the call between the C-subscriber and the D-subscriber will be established using the network 10,15 interfaces 55 between the MSC 30 and MSC 70 well known to those skilled in the art.

In FIG. 4C, in step 1100, the call between the A-subscriber and B-subscriber is disconnected at time equal to 0:03 minutes. At this time, the remaining portion of the allocated talk time for the A-subscriber is 2 minutes, which will be returned to update the record 57 as the second updated prepaid talk time in step 1100. The call between the C-subscriber and the D-subscriber is still in progress, and the E-subscriber operating the telephone 65 initiates a call to the F-subscriber, operating the telephone 95. At the time of the call, the C-subscriber, operating the telephone 25, has 6 minutes remaining as a portion of the allocated talk time. The E-subscriber is allocated 9 minutes as a portion of the total prepaid talk time in step 1110. The total talk time is then decremented by 9 minutes in step 1120 and updated in step 1130 to a value of 81 minutes (i.e., 88 minutes plus 2 minutes credit by the A-subscriber minus 9 minutes allocated to the C-subscriber).

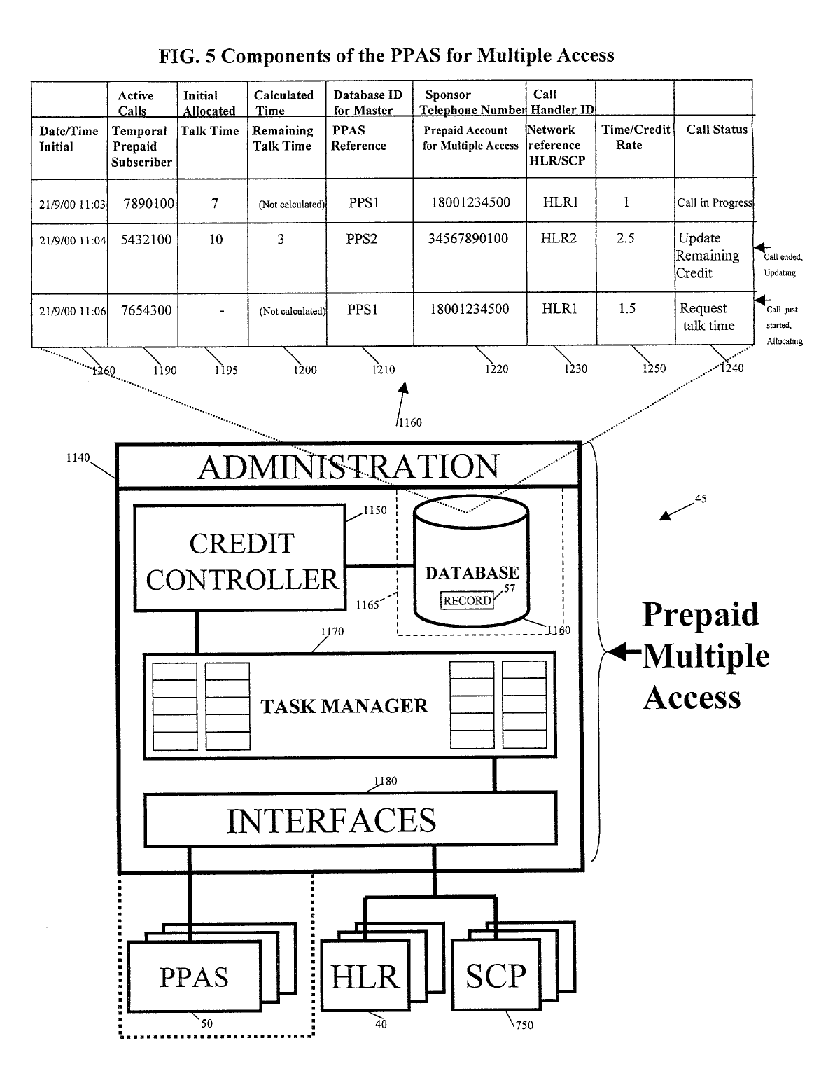

Turning now to FIG. 5, the database of the present invention can be seen. The database 1160 may be housed within the PPAS 45, or exist within a separate node. The record 57 may constitute any one or more of the fields in the database 1160. For example, the record 57 may include one or more of the identity fields 1190 for subscribers, and/or one or more of the remaining talk time fields 1200 associated with the subscribers, and/or one or more of the sponsor identity fields 1220 associated with any of the subscriber identities 1190. The identity fields 1190 include the telephone numbers of the virtual subscribers engaged in active call connections. The database 1160 may also include a recording of the initial allotted time for each of the subscribers in the allotted time fields 1195. The calculated remaining time may be maintained and updated in the remaining times fields 1200.

The database 1160 may also contain database identification references for the associated PPAS 45 in order to identify the correct PPAS associated with the call in cases where the network has several PPAS nodes. The sponsor identity fields 1220 usually contain the telephone numbers of the actual prepaid account sponsors, and SCP/HLR (or MSC) network reference numbers may be contained in the network reference fields 1230. Also the database 1160 may include the Date-Time Initial 1260 (which indicates the date and time of the call) and the Time/Credit Rate information 1250, both associated with the subscribers' identities 1190. Finally, the database 1160 may include status fields 1240 which indicate the particular status of any ongoing call.

The PPAS MCA 45 typically contains an administration element 1140 which takes care of the administration and supervision aspects of the PPAS MCA 45 with regard to configuration of prepaid communications accounts, reports, statistics, maintenance of the database 1160, and alarms. The PPAS MCA 45 also typically contains a credit controller element 1150 which assigns the portion of time allocated to a particular subscriber's call after origination, and passes information to and from the PPAS, as well as updating the PPAS MCA database 1160. The task manager 1170 controls and regulates the information passing between the network interfaces 1180 and the credit controller 1150. The interfaces 1180 isolate the PPAS MCA 45 from external network components, such as the PPAS 50, the HLR 40, and the SCP 750.

As noted above, the invention may also include a memory element 1165, such as a random access memory, which is used to store the database 1160.

Although the invention has been described with reference to specific embodiments, this description is not meant to be construed in a limited sense. The various modifications of the disclosed embodiments, as well as alternative embodiments of the invention, will become apparent to persons skilled in the art upon reference to the description of the invention. It is, therefore, contemplated that the appended claims will cover such modifications that fall within the scope of the invention, or their equivalents.

What is claimed is:

1. A method of managing access to a prepaid communications account shared by at least a first subscriber and a second subscriber, comprising the steps of:
locking access to the prepaid account in response to a first prepaid call origination from the first subscriber;
allocating a first portion of a total prepaid talk time to a first prepaid call to be established responsive to the first prepaid call origination;
updating the total prepaid talk time to provide a first updated prepaid talk time by subtracting the first portion from the total prepaid talk time;
unlocking access to the prepaid account; and
while the first prepaid call is established, locking access to the prepaid account in response to a second prepaid call origination from the second subscriber;
allocating a second portion of the first updated prepaid talk time to a second prepaid call to be established responsive to the second prepaid call origination;
updating the first updated prepaid talk time to provide a second updated prepaid talk time by subtracting the second portion from the first updated prepaid talk time; and
unlocking access to the prepaid account.

2. The method of claim 1 wherein the prepaid communications account is associated with a prepaid telephone number.

3. The method of claim 1, further including the step of:
receiving the first prepaid call origination including the prepaid telephone number from the first subscriber.

4. The method of claim 3 further including the step of:
receiving the second prepaid call origination including the prepaid telephone number from the second subscriber.

5. The method of claim 2, wherein a first call connection is established between the first subscriber and the prepaid telephone number.

6. The method of claim 5, wherein a second call connection is established between the second subscriber and the prepaid telephone number.

7. The method of claim 1, wherein the first prepaid call is established between the first subscriber and a first called party.

8. The method of claim 7, wherein the prepaid communications account is associated with a prepaid telephone number, and wherein the first called party is associated with a first called party telephone number, further including the step of:
receiving the first prepaid call origination including the prepaid telephone number and the first called party telephone number.

9. The method of claim 8, wherein the second prepaid call is established between the second subscriber and a second called party.

10. The method of claim 9, wherein the second called party is associated with a second called party telephone number, further including the step of:
receiving the second prepaid call origination including the prepaid telephone number and the second called party telephone number.

11. The method of claim 1, further including the step of:
announcing the first portion of the total prepaid talk time to the first subscriber.

12. The method of claim 11, further including the step of:
announcing the second portion of the first updated prepaid talk time to the second subscriber.

13. The method of claim 1, further including the step of:
monitoring an unused portion of the first portion of the total prepaid talk time as a remaining portion that is reduced while the first prepaid call is established.

14. The method of claim 13, wherein the remaining portion is about equal to zero, further including the step of:
dropping the established first prepaid call.

15. The method of claim 13, wherein the established first prepaid call is terminated, and wherein the remaining portion is about greater than zero, further including the steps of:
locking access to the prepaid account;
updating the previously updated prepaid talk time by adding the remaining portion to the previously updated prepaid talk time; and
unlocking access to the prepaid account.

16. The method of claim 13, further including the steps of:
locking access to the prepaid account;
allocating an additional portion of the first updated prepaid talk time to the first prepaid call before the remaining portion is about equal to zero;
updating the remaining portion by adding the additional portion to the remaining portion; and
unlocking access to the prepaid account.

17. The method of claim 13, further including the step of:
announcing the remaining portion to the first subscriber.

18. The method of claim 13, further including the step of:
announcing the remaining portion to the first subscriber on a preselected periodic basis.

19. A database for managing access to a prepaid communications account shared by at least a first subscriber and a second subscriber, including:
a first identity field for the first subscriber;
a first remaining talk time field associated with the first identity field;
a first time/credit rate field associated with the first identity field;
a second identity field for the second subscriber;
a second remaining talk time field associated with the second identity field;
a second time/credit rate field associated with the second identity field; and
a sponsor identity field associated with the first and second identity fields.

20. The database of claim 19, further including:
a first network reference field associated with the first identity field.

21. The database of claim 20, further including:
a second network reference field associated with the second identity field.

22. A memory element used to store a database for managing access to a prepaid communications account shared by at least a first subscriber and a second subscriber, including:
a first identity memory location associated with the first subscriber;
a first remaining talk time memory location associated with the first identity memory location;
a second identity memory location associated with the second subscriber;
a second remaining talk time memory location associated with the second identity memory location; and
a sponsor identity memory location associated with the first and second identity memory locations.

23. The memory element of claim 22, including:
a first network reference memory location associated with the first identity memory location.

24. The memory element of claim 23, including:
a second network reference memory location associated with the second identity memory location.
